(19) United States
(12) Patent Application Publication
(10) Pub. No.: US 2006/0198528 A1
(43) Pub. Date: Sep. 7, 2006

(54) Interactive content sound system

(75) Inventors: Mark Tuffy, San Rafael, CA (US); Steve Martz, San Rafael, CA (US)

Correspondence Address: CROCKETT & CROCKETT, 24012 CALLE DE LA PLATA, SUITE 400, LAGUNA HILLS, CA, 92653, US

(73) Assignee: THX, Ltd.

(21) Appl. No.: 11/365,040

(22) Filed: Mar. 1, 2006

Related U.S. Application Data
(60) Provisional application No. 60/658,301, filed on Mar. 3, 2005.

(51) Int. Cl. H04R 5/00

(52) U.S. Cl. 381/23; 381/22; 381/19

(57) ABSTRACT

A sound encoding and decoding technique for interactive content according to the present disclosure provides additional sound channels encoded in real time from 3D audio vector and level information. The additional channels are encoded into the native sound channel format for compatibility with legacy equipment. Decoding equipment compatible with the present disclosure decodes the native sound stream and extracts the additional channels to provide a more immersive interactive sound experience.

### RELATED APPLICATIONS

This application claims priority of copending U.S. provisional patent application Ser. No. 60/658,301 filed Mar. 3, 2005.

### FIELD OF THE INVENTIONS

The inventions described below relate generally to the field of sound encoding and reproduction and more specifically to multi-channel sound encoding and decoding for interactive digital content.

### BACKGROUND OF THE INVENTIONS

Multichannel audio content delivery has a channel limitation imposed by the number of channels available in the codec technology for most types of content. This results in a multichannel replay which is unable to place sounds accurately due to gaps in the 360° surround field. For a truly immersive audio experience, more channels are needed.

Conventional solutions for this type of encode/decode process are not available. Many companies such as Dolby, SRS, Trifield, Creative, THX, etc. offer a process or an algorithm that provides “extractions” or “upmixes” of additional surround that provides “extractions” or “upmixes” of additional surround channels from pre-existing stereo or 5.1 material. In general these additional channels are not previously encoded in the content but are derived and predicted from pre-recorded content. The technologies in use today also are aimed at providing only surround channels to fill a 5.1 or 7.1 replay system. The systems are not designed to lay encoded additional channel content over a 5.1 pipeline, especially for interactive content.

Encoders for six channels or more are currently targeted for the addition of a single back channel for pre-recorded cinematic content in theatres and DVD's. Companies such as Dolby and dts have created products to provide an extra surround channel for pre-recorded content. The 6.1 encoder adds a back surround channel.

What is needed is a sound encoder/decoder for interactive content to allow the creation of additional audio channels and transmit them over a standard 2.0 or higher encoding codec without the need to increase the channel count of the codec technology. The extra channels of audio may be extracted by a complimentary decoding engine which shall operate on the audio after passing through the codec decoding engine.

The encoding/decoding technology may be codec agnostic and can work in any application where two or more channels of audio can be delivered from content. This has applications in motion picture, DVD, live broadcast content, music, and game content.

### SUMMARY

A sound encoding and decoding technique for interactive content according to the present disclosure provides additional sound channels encoded in real time from 3D audio vector and level information. The additional channels are encoded into the native sound channel format for compatibility with legacy equipment. Decoding equipment compatible with the present disclosure decodes the native sound stream and extracts the additional channels to provide a more immersive interactive sound experience.

An interactive game encoder according to the present disclosure encodes additional channels into two or six channels or bit streams and decodes them in a consumer device such as a home theatre receiver. The game encoder will derive extra channels from analysis of the audio vector and level information as it is being interactively produced. The additional channels may be folded down into existing channels for transmission over the traditional codec platforms. The additional channels can either be reproduced if the complimentary decoder is applied, or left for playback in the existing channels. This approach provides full backwards compatibility with legacy playback devices.

An interactive game encoder system according to the present disclosure may use digital frequency domain spectral analysis techniques to create additional audio channels. A corresponding spectral technique may be used to extract the additional channels in the decode process.

In another aspect, an interactive game encoder system may include any suitable encode/decode technique using digital or analog spectral techniques to create additional channels as the content is being manipulated during game play. An additional technique for a game encoder may include proportional addition and subtraction of channels to encode and then decode the additional channels into native sound channels in a composite system.

An interactive content sound encoder system according to the present disclosure may include an embedded run-time algorithm in the content production tools. This may reside in mixing consoles, software multichannel production tools or in the interactive content. As the content is performed and interaction occurs, the sound encoder system will run in real-time and encode the additional sound channels.

These and other features and advantages will become further apparent from the detailed description and accompanying figures that follow. In the figures and description, numerals indicate the various features of the disclosure, like numerals referring to like features throughout both the drawings and the description.

### BRIEF DESCRIPTION OF THE DRAWINGS

FIG. 1 is a block diagram of an interactive content system according to the present disclosure.

### DETAILED DESCRIPTION OF THE INVENTIONS

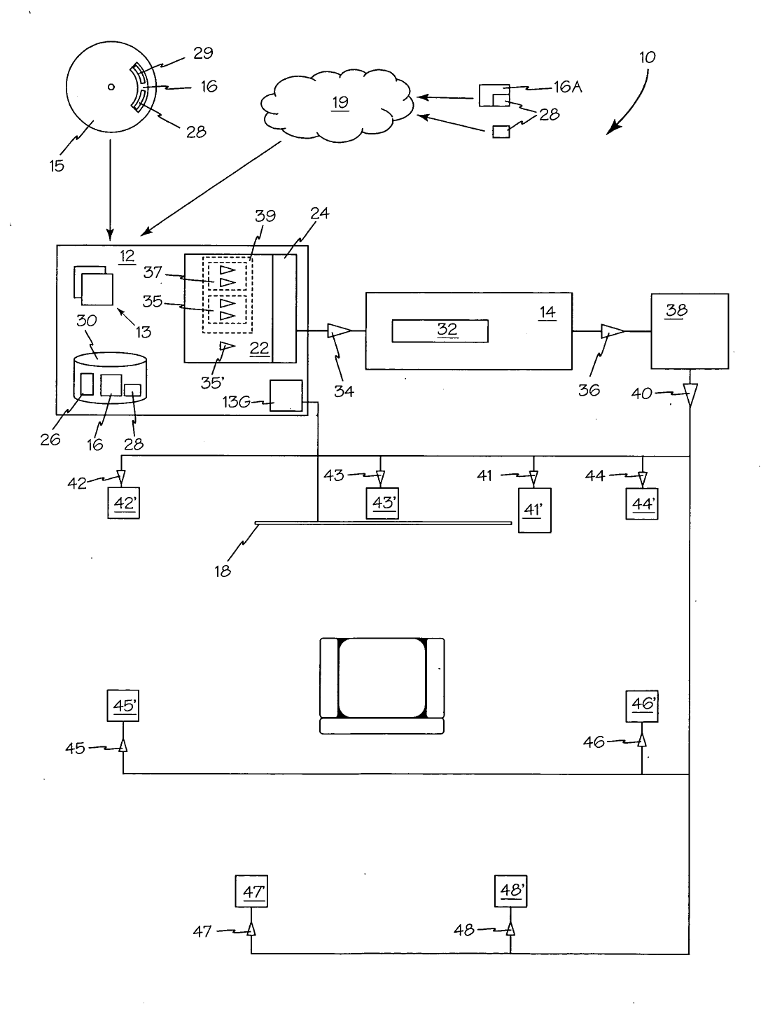

Referring now to FIG. 1, interactive content system 10 may include any suitable interactive content decoder, for example a game console, such as console 12 connected to sound receiver 14 and display 18 for performance of any suitable interactive content such as game content 16. Interactive content system 10 is shown configured for eight channel audio although the principle may also be applied to other interactive content that produces a multichannel audio stream. Interactive content such as game content 16 or 16A and or immersion encoder 28 may be delivered to console 12 using any suitable delivery technique such as but not limited to media 15 such as CD, DVD, HD-DVD, flash memory, or any other suitable digital media or through a network such as network 19.

Examples presented herein are illustrative and may reference X.1 channels as is the current convention. The .1 channel is referring to subwoofer frequencies or a subwoofer channel. The following examples may have renamed the .1 channel or subwoofer channel 41 as an additional sound channel for clarity. Thus 7.1 sound may be discussed herein as eight channel sound.

To provide an eight channel audio soundtrack such as audio stream 40, audio engine 22 may produce two or more additional surround sound streams or channels 39 for native encoder 24. In the present example, audio engine 22 may produce 4 surround channels as stream 39. In the present example, surround stream 39 includes two native channels 35 and two additional immersion channels 37. Game audio engine 22 may use in-game audio vector and level information from content 16 and or derived from interactive content algorithms which may be stored as data 26 in memory 30. Data 26 may be used by game audio engine and or other suitable apparatus to generate eight outputs, streams, or channels such as native channels 41, 42, 43, 44, 45 and 46, and additional immersion channels 47 and 48 instead of six native sound channels. Immersion encoder 28 causes audio engine 22 and or other suitable apparatus to produce one or more additional sound channels such as immersion surround channels 47 and 48 in addition to the native sound channels. Encoder 28 further causes audio engine 22 to combine one or more additional sound channels 39 into composite native channels 35′ and then pass the six channel content to native encoder 24.

In a game specific version of the present disclosure, immersion encoder 28 is agnostic to the native six channel encoder format and encoding algorithm 29 may run either on audio hardware in console 12 or on unused graphics processor (GPU) cycles in graphics processor 13G or on processors 13, or in any other suitable technique. Conventional digital decoders such as decoder 32 in receiver 14 may decode audio bit stream 34 into six channels such as audio stream 36. Immersion decoder 38 may further extract the 4 surround channels, two native channels and two additional immersion channels, from the two channels present in the six channel mix to produce eight channel immersion playback such as audio stream 40.

In a game specific example, interactive content system 10 may use any suitable technique such as a 4-2 digital frequency domain spectral technique to create a stereo pair such as composite native channels 35′ from the two native surround channels and the two additional surround channels. A corresponding 2-4 digital frequency domain spectral technique may be used to extract the additional back channels such as immersion channels 47 and 48 in the decode process of immersion decoder 38.

In additional implementations the encode/decode techniques may be any suitable technique such as but not limited to a 4-2-4 digital or analog matrix topology to create the stereo pair. An additional implementation technique for encoder 28 may use proportional addition and subtraction of Ls, Rs, Bls, and Brs surround channels to encode and then decode the four channels into two channel and then to four channels. The encoded two channel composite signal may be delivered to the native digital encoder as described above.

The techniques of the present disclosure may reside as an embedded run-time algorithm 29 in any suitable interactive content such as game content 16. As the game is played the sound encoding technique will run in real-time and through analysis of the 3D audio parameters encode the additional surround channels. An additional implementation may allow the present technique to reside in game playback hardware such as console 12, running on either the audio subsystem 22, graphics processor 13G or on the system CPU 13.

An additional game based implementation according to the present disclosure may be applicable to playback platforms with two digital or analog sound channel outputs. In this technique, sound encoding may be designed to encode additional channels into the native two channel audio and decode the additional channels using a consumer device such as a home theatre receiver, such as receiver 14, for eight channel playback. Encoder 29 may derive a centre channel and four surround channels in addition to the two native channels from the game's audio engine. The additional channels will be folded down into the native stereo pair. The native stereo channels may be reproduced as two channels or decoded into eight channels of immersive sound. This approach provides full backwards compatibility with legacy playback devices.

Interactive audio engine 22 may need to produce six or more channels for the native encoder. This may be accomplished by using the in-game audio vector and level information through immersion encoder 28 to specify eight output channels. Immersion encoder 28 may combine the six or more additional immersion channels into the two native channels and pass the encoded sound content to the native output of the console. The sound content encoder is agnostic to the native format and the immersion encoding algorithm may run either on the audio hardware, and or on unused graphics processor (GPU) cycles, and or on the central system processor or processors. The disclosed decoder may be an additional device such as decoder 38, or it may be included in a consumer device such as decoder 38A included in receiver 14. Decoder 38 or 38A may extract the six additional channels from the native two channels present in the mix to produce an immersive eight channel playback in audio stream 40.

The encode system may use a 7-2 digital frequency domain topology to create the stereo pair. A corresponding 2-7 digital frequency domain spectral technique may be used to extract the additional channels in the decode process.

Sound encoding according to the present disclosure may reside as an embedded run-time algorithm such as algorithm 29 in sound encoder 28. Sound encoder 28 may be included in any suitable interactive digital content such as content 16. Alternatively, sound encoder 28 may be provided by any other suitable means such as through network 19. As the interactive digital content is manipulated, sound encoder 28 and algorithm 29 may run in real-time and encode the additional surround channels. An additional implementation allows a suitable sound encoder such as sound encoder 28 to reside in game playback hardware such as memory 30, and running on audio engine 22, graphics processor 13G or on one or more system CPUs 13.

In the illustrated example four surround speakers present the native surround channels and the additional immersion channels. Native channels Left Surround 45′ and Right Surround 46′ may be presented along with additional immersion channels Back Left Surround 47′ and Back Right Surround 48′. The surround speakers may be located at any suitable position with reference to the center channel position of center speaker 43′.

While the example above describes the production of additional surround channels for interactive content replay, the disclosed technique may be used to provide additional channels in any point of a horizontal 360-degree plane around the user for any content which requires more than six channels of encoded audio information. The encoded data can be delivered on previously encoded media such as DVD or game cinematics and/or audio media created “on the fly” such as real-time game play, or live broadcasts. The topology of the encoder and decoder are scalable to provide any desired number of replay channels.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

We claim:

1. A method of producing immersive sound for interactive content comprising the steps:
generating seven or more sound channels in response to content interactions using audio vector and level information;
encoding the seven or more sound channels into a six channel audio stream; and
decoding the six channel audio stream into seven or more sound channels.

2. The method of claim 1 wherein the step of generating seven of more sound channels further comprises the steps:
importing an immersion encoder algorithm;
generating seven or more sound channels in response to content interactions using the immersion encoder algorithm and audio vector and level information.

3. The method of claim 1 wherein the steps of encoding the seven or more sound channels, and decoding the six channel audio stream further comprises the steps:
encoding the seven or more sound channels into a two channel audio stream; and
decoding the two channel audio stream into seven or more sound channels.

4. A sound system comprising:
means for generating seven or more sound channels in response to content interactions using audio vector and level information;
means for encoding the seven or more sound channels into a six channel audio stream; and
means for decoding the six channel audio stream into seven or more sound channels.

5. The sound system of claim 4 wherein the means for generating seven of more sound channels further comprises:
an immersion encoder algorithm;
means for generating seven or more sound channels in response to content interactions using the immersion encoder algorithm and audio vector and level information.

6. A sound system for interactive content comprising:
a content player having a memory, one or more processing units, a sound processor for generating seven or more sound channels in response to content interactions using audio vector and level information, and a video processor;
means for encoding the seven or more sound channels into a six channel audio stream; and
means for decoding the six channel audio stream into seven or more sound channels.

7. The sound system of claim 6 wherein the means for encoding the seven or more sound channels, and the means for decoding the six channel audio stream further comprise:
means for encoding the seven or more sound channels into a two channel audio stream; and
means for decoding the two channel audio stream into seven or more sound channels.

8. The sound system of claim 6 wherein the content player further comprises:
a content player having a memory, a video processor, one or more system processing units, a sound processor for generating six sound channels in response to content interactions using audio vector and level information, and an immersion encoder for encoding one or more additional sound channels in response to content interactions using audio vector and level information.

9. The sound system of claim 8 wherein the immersion encoder and the audio vector and level information are processed by one or more system processing units.

10. The sound system of claim 8 wherein the immersion encoder and the audio vector and level information are processed by the video processor.
